(19) United States
(12) Patent Application Publication
(10) Pub. No.: US 2012/0242151 A1
(43) Pub. Date: Sep. 27, 2012

(54) DATA CENTER TOPOLOGY WITH LOW STS USE

(75) Inventors: Scott Thomas Seaton, Kirkland, WA (US); Allan Joseph Wenzel, Seattle, WA (US)

(73) Assignee: MICROSOFT CORPORATION, Redmond, WA (US)

(21) Appl. No.: 13/167,511

(22) Filed: Jun. 23, 2011

Related U.S. Application Data
(60) Provisional application No. 61/466,436, filed on Mar. 22, 2011.

(51) Int. Cl. H02J 4/00; H01R 43/00

(52) U.S. Cl. 307/65; 29/825

(57) ABSTRACT

Equipment in a data center may be wired in a topology in which each piece of equipment is served by one Static Transfer Switch (STS). Each group of equipment is assigned a main UPS and a reserve UPS, which may be connected to an underlying power source such as a utility. The main UPS and the reserve UPS are connected to the first and second inputs of an STS. For dual-corded equipment, the first cord is served by the output of the STS, while the second cord is served by the main UPS without an intervening STS. Thus, if the main UPS fails, the STS transfers power to the second UPS, thereby allowing the first cord to be powered. The second cord, not being served by the STS, simply loses power, thereby doubling the power draw at the first cord at roughly the same time that the transfer occurs.

### CROSS-REFERENCE TO RELATED CASES

This application claims the benefit of U.S. Provisional Patent Application No. 61/466,436, entitled “Data Center Topology”, filed on Mar. 22, 2011.

### BACKGROUND

A data center is a facility that has computer systems and associated components. Data centers are generally expected to meet certain standards of availability and reliability, so the computers in data centers are often configured and connected in ways that are designed to resist certain types of failures. One type of failure that a data center guards against is a failure of electrical power.

In order to keep the computers running in the event of a power failure, various mechanisms are employed. A computer in a data center is often dual-corded, so that the computer can continue to operate even if the power at one cord fails. Additionally, a group of computers may be served by an Uninterruptable Power Supply (UPS), which allows power delivery to continue without interruption even if the underlying power source (e.g., the regional utility) fails. Moreover, a UPS itself can fail, so there may be both a main UPS and a reserve UPS. If the main UPS fails, power delivery is switched from the main UPS to the reserve UPS.

The set of mechanisms that allow a transfer of power from one UPS to another can be expensive. Using a large number of these mechanisms can be a significant expense associated with a data center.

### SUMMARY

Computers in a data center can be wired in a topology in which each computer in the center receives power through only a single Static Transfer Switch (STS). A group of computers in the data center is connected to utility power through a main UPS. One input of an STS is connected to the main UPS, and another input of the STS is connected to a reserve UPS. The output of the STS is connected to one power distribution unit (PDU) for a rack. The UPS is then also connected, without an intervening STS, to another PDU for the rack. For each dual-corded server in the rack, one cord is connected to the first PDU, and the other cord is connected to the second PDU. Thus, the first cord of the server receives power through an STS, and the second cord receives power not through an STS.

If the main UPS fails, the STS transfers power from the main UPS to the reserve UPS, thereby allowing the first PDU of the rack to continue to receive power without interruption. However, the second PDU of the rack—not being connected to an STS and, therefore, not being able to receive power from the reserve UPS when the main UPS fails—simply loses power. Thus, the servers in the rack increase their load on the first PDU to compensate for the loss of power at the second PDU, so the servers, or other devices in the rack, continue to receive power without interruption. Since the loss of power on the rack's second PDU increase the load on the STS that powers the first PDU, the failure of the main UPS effectively causes a significant increase in load on the STS to happen concurrently with the transfer of power from the main UPS to the reserve UPS. Thus, in order to implement this topology, an STS is chosen that can handle an increase in load during a transfer, while also possibly being able to deal with the power from the main and reserve UPSs being out of phase.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example arrangement in which equipment may be connected to power.

FIG. 2 is a block diagram of an example data center.

FIG. 3 is a flow diagram of an example process that may be used to wire a data center.

FIG. 4 is a flow diagram of an example process that may occur during failure of a UPS.

### DETAILED DESCRIPTION

A data center is a facility that has computer systems and associated components. The computers that are in data centers are generally expected to meet certain standards of availability and reliability. For example, a data center may contain the computers that store financial records for a financial institution, that host the web servers for an on-line store, or that perform some other function for which downtime is either costly or undesirable.

Data centers can be designed to guard against various sources of failure—e.g., fire, flood, earthquake, etc. However, one source of failure that a data center generally guards against is electrical power failure. If the data center, or some part of the data center, were to lose power completely without a backup source of power, the computers would abruptly shut down. The unavailable of computers due to a lack of power is, in itself, a problem. However, an ungraceful shutdown may compound the problem, since—even when power is restored—a computer that has been shutdown abruptly may be in a bad state, and it may take significant time to restore the computer to a valid state so that the computer can be brought back online. In some cases, abruptly shutting down a computer could damage the computer's hardware. Thus, data centers generally contain backup systems to ensure that power will continue to be delivered to the computers—or, at least, that power will not be lost abruptly so that systems can be shut down smoothly.

In order to ensure continuous delivery of power, a data center may be wired in the following way. Power from a generator source (e.g., a regional utility) is provided to the data center. An Uninterruptable Power Supply (UPS) is connected downstream from the generator source. A group of racks in the data center is assigned to use that UPS as its “main” UPS. Thus, if the generator source fails (e.g., in the case that power from the utility becomes disconnected, or an upstream circuit breaker at the data center trips), the UPS continues to deliver power to the racks in its assigned group.

Typically, each of the racks has two power strips, or “power distribution units” (PDUs). The servers in the rack may be dual-corded (either by powering a server through two power supplies, or by powering a server through a single dual-corded power supply). For a given server, one cord may be connected to one PDU, and another cord may be connected to the other PDU. During normal operation, the server receives roughly equal amounts of power through each cord, but the dual-cording allows the server to receive power even if power is lost at one of the PDUs.

The PDUs may be connected to the main UPS for the group in the following way: One power panel may be connected to the UPS through a Static Transfer Switch (STS), and the other power panel may be connected to the UPS without any intervening STS. An STS is an electrical component that receives two power inputs, and passes the power through to an output. The STS draws power from one input unless that input fails, in which case the STS draws power from the other input. One input of the STS is connected to the main UPS. The other input is connected to a reserve UPS, which is a UPS that is designated to deliver power to the group in case the main UPS fails. (The reserve UPS may be assigned solely to the same group of racks as the main UPS. Or, a reserve UPS may be shared among several groups of racks.) If the main UPS fails, the STS transfers power to the reserve UPS, so the PDU that is connected to the STS continues to receive power through the STS, where the power (after the transfer) comes from the reserve UPS instead of the main UPS. However, the other PDU, which is connected directly to the main UPS that has now failed, loses power. Thus, the dual-corded servers in the rack stop drawing power from the PDU that has lost power, and instead increase their load on the PDU that still has power.

Since the increase in load on one of the PDUs increases the load on the STS that is powering that panel, and since this increased load happens at about the same time as the transfer of power from the main UPS to the reserve UPS, the particular STS that is used may be chosen to be one that can handle a load change during a power transfer. Moreover, since the power coming from the main UPS and the power coming from the reserve UPS may be out of phase with each other, the STS may be chosen to be able to handle a load change during a transfer while also handling a transfer between out-of-phase power sources. (Such STSs are available under the Cyberex brand from Thomas & Betts, or the Liebert brand from Emerson.)

One example topology for a data center connects each group of racks to two STSs. In such a topology, one PDU on a rack is connected to one STS, and the other PDU is connected to another STS. Each STS receives input from the main UPS and also from the reserve UPS, so that—if the main UPS fails—both STSs transfer power to the reserve UPS, thereby allowing both PDUs on each rack to continue to be powered. However, this design involves the uses to two STSs for each group of servers. The design in which one of the PDUs is connected to an STS, and the other is not, allows the data center to be built with half the number of STS that would otherwise be used, thereby reducing the overall equipment cost of the data center.

The ability to use a single STS where other designs would use two is based on the ability of certain advanced STSs to handle a significant load change during a transfer between (possibly) out-of-phase power sources. However, it will be noted that the topology that makes use of a single STS per group of racks—in which only one PDU of each rack is connected to two UPSs through an STS—is not a natural or obvious consequence of the STS's ability to handle a load change during a transfer, or of the ability of the STS to handle out-of-phase transfers. Data centers have not been known to be implemented according to a topology in which each rack in a group has one PDU connected to two UPSs through an STS, but in which the other PDU is not connected to an STS (thereby subjecting the other PDU to a complete loss of power if the main UPS fails). Data centers that have such topologies have not been known to be implemented, even if STSs that can handle these conditions that were available, and despite the significant cost savings that could have resulted from a design that used fewer STSs.

Moreover, it is noted that the subject matter herein is not a single-corded design. That is, the subject matter herein cannot be derived from designs (if they exist) in which a single-corded device is connected to an STS that transfers between different UPSs and/or power sources, and in which there is no second cord. By contrast, the subject matter herein allows for dual-corded equipment, but powers such equipment in a way that allows the dual-corded equipment to change to single-corded operation in the event of a UPS outage as a way of reducing the number of STSs that would otherwise be used to maintain dual-corded operation. Such a design is fundamentally different from wiring topologies used with equipment that has only one cord, and cannot be inferred or derived from such single-corded topologies.

Additionally, some designs construe STSs and dual-cording as alternatives to each other, rather than strategies that can supplement each other. Designs that use dual-corded equipment such that one UPS is connected to one cord and another UPS is connected to another cord assume that the equipment will draw from both UPSs at the same time during normal operation. These designs do not allow for the notion of a reserve UPS that comes into use in response to the failure of the main UPS. Moreover, such designs do not make use of the features of an STS that can execute a transfer between (possibly out of phase) sources during a significant load increase.

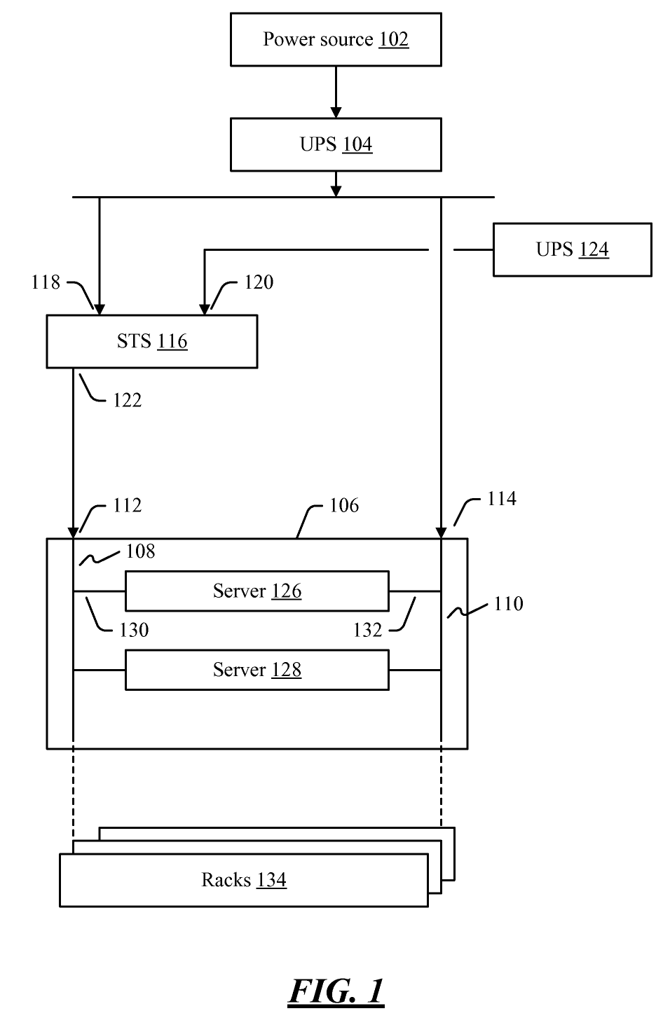

Turning now to the drawings, FIG. 1 shows an example arrangement in which equipment may be connected to power. In the example arrangement of FIG. 1, power comes from power source 102. Power source 102 may be power generated by a public utility (e.g., a local, regional, or national electric company) or a private generation facility. Power source 102 may be generally reliable, while still being subject to occasional failures or drops in voltage. Thus, to protect the reliable delivery of power, power source 102 may be connected to UPS 104. UPS 104 contains mechanisms that continue the delivery of power to a downstream load, even if power source 102 fails. UPS 104 may be implemented using any appropriate mechanisms, such as batteries, flywheels, etc. (The “U” in UPS stands for “uninterruptable.” However, it will be understood that no device is 100% failure-proof. The fact that a particular UPS device might have a non-zero failure rate does not negate its status as a “UPS”.)

In the example of FIG. 1, the load to which power source 102 and UPS 104 deliver power is equipment in rack 106. Rack 106 is a physical structure that may hold servers or other types of computing or electrical equipment. Rack 106 may have a plurality of PDUs. In the example shown in FIG. 1, rack 106 has two PDUs 108 and 110. PDUs 108 and 110 may be electrical busses with outlets into which equipment can be plugged. Each PDU may receive power from a separate input. Thus, PDU 108 receives power through input 112, and PDU 110 receives power through input 114.

PDUs 108 and 110 may be connected to power in the following way. PDU 112 receives power through STS 116. As described above, an STS has two power inputs 118 and 120, and an output 122. STS 118 passes power from input 118 through to output 122, as long as power is actually being received at input 118. If power is lost at input 118, or if it degrades below a certain level (e.g., if the voltage drops below a certain level), then STS 116 transfers its source of power from input 118 to input 120, thereby ceasing to pass through power from input 118 and, instead, passing through power from input 120. STS 116 may be designed to manage this transfer of power smoothly, so that the power coming through at output 122 shows little or no sign of voltage dips or phase changes as a result of the transfer. Thus, STS 118 can provide reliable power to its load, regardless of which input STS 118 is receiving power from, and even during the time that STS 118 is changing from one input to the other.

In the topology shown in FIG. 1, the two inputs 118 and 120 of STS 116 are connected to UPS 104 and UPS 124. UPS 104 may be considered the “main” UPS for a particular rack or group of racks, and UPS 124 may be considered the “reserve” UPS for that group of racks. In one example, each group of racks has its own main UPS, while several groups of racks share a reserve UPS (on the theory that it is unlikely that the UPS for several racks will fail at the same time). However, UPS 124 could be dedicated to a particular group of racks, or could be shared in any appropriate manner. Since UPS 104 is connected to input 118, and UPS 124 is connected to input 120, based on the discussion above it will be understood that STS 116 draws power through UPS 104 unless the power coming from UPS 104 degrades below some level (or fails completely), in which case STS 116 starts to draw power from UPS 124. It will also be appreciated that, in the topology shown in FIG. 1, UPS 124 is not connected to PDU 110 in any manner that would allow PDU 110 to draw power from UPS 124. Thus, unlike PDU 108, which uses STS 116 to draw power from either UPS 104 or UPS 124 depending on which UPS is available, power at PDU 110 is subject to the availability of power from UPS 104. If UPS 104 and/or its upstream power source 102 fail to deliver power, then PDU 110 simply loses power, and stops being able to deliver power to its loads. (PDU 110, and the cords that receive power from PDU 110, may be described as having no connection through which they can draw power from UPS 124.)

Rack 106 may contain various pieces of equipment. In the example shown in FIG. 1, rack 106 contains two servers 126 and 128, although rack 106 could contain other types of equipment (e.g., network routers or switches, cooling fans, etc.). (Servers, routers, switches, fans, or other equipment that can be powered—whether or not such equipment is mounted or mountable in a rack—may be referred to herein as an “equipment unit.”) A piece of equipment in rack 106 may be dual corded. For example, server 126 has cords 130 and 132, which are connected to PDUs 108 and 112, respectively. As described above, dual-corded equipment plugged into two PDUs can continue to operate even if power is lost at one of the PDUs. In normal operation, dual-corded equipment draws roughly half its power from each cord, but if power to one cord is lost the equipment simply shifts its entire power draw to the other cord.

Thus, if power ceases to be delivered from UPS 104 (e.g., because power source 102 has failed to deliver power and/or because UPS 104 has failed to operate correctly), then the following is what happens. STS 116 transfers its power input from UPS 104 to UPS 124. At approximately the same time, PDU 110 loses power. Thus, at the time that PDU 110 loses power, the dual-corded equipment in rack 106 increases its load on PDU 108 which, in turn, increases the load on STS 116. In other words, the load on STS 116 is increasing at approximately the same time as STS 116 is performing the transfer of power input from UPS 104 to UPS 124. STS 116 may be chosen to be an advanced design, which can handle this increase in load during the performance of a transfer. STS 116 may also be chosen to handle the load increase during a transfer even if STS 116's two source of input (UPS 104 and UPS 124) are out of phase with each other.

It is noted that the foregoing discussion shows a single rack 106 being connected to power in the manner described. However, one or more additional racks 134 could be connected in this manner. E.g., there could be a plurality of racks, each with two PDUs, where one of the PDU's in a rack receives power through STS 116, and the other PDU in the rack receives power directly from UPS 104. In this way, groups of racks could be powered using the topology shown in FIG. 1.

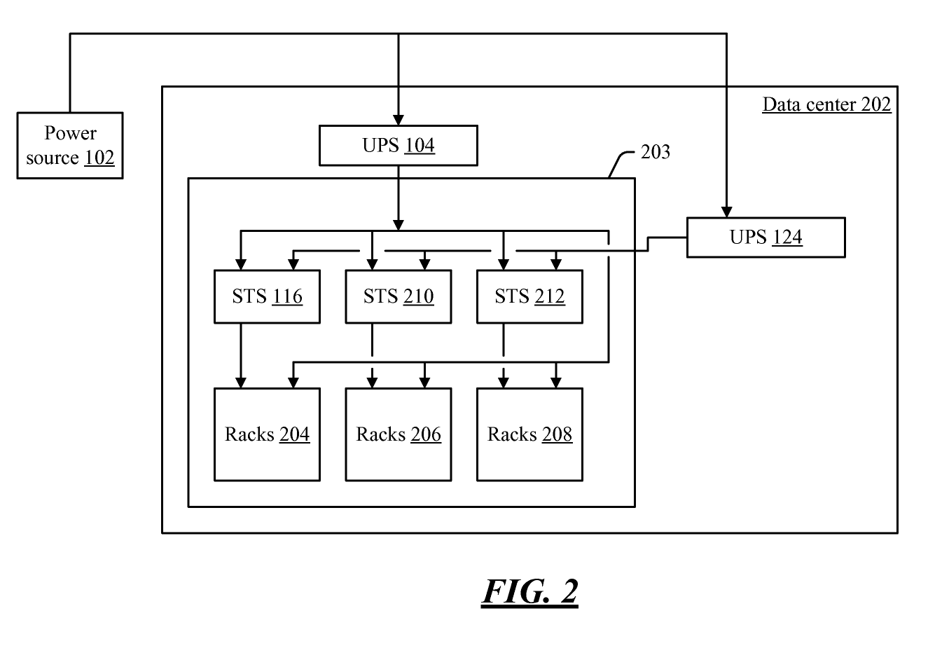

A group of servers powered according to the topology shown in FIG. 1 may be part of a data center. An example of such a data center is shown in FIG. 2.

Data center 202 may have a building, a portable container, or another structure, that houses computers. In one example scenario, the computers are mounted on racks, and several racks are clustered together in a group. FIG. 2 shows a group 203 which contains several sets of racks—i.e., racks 204, racks 206, and racks 208. Each of the racks may contain servers (as shown in FIG. 1), or other types of equipment. Typically, each group of racks is assigned to a particular main UPS. In the example of FIG. 2, UPS 104 is the main UPS for group 203. UPS 124 is the reserve UPS for group 203. UPS 124 may be a dedicated reserve UPS for group 203, or may be shared among group 203 and other groups of racks in data center 202. Group 203 may have one or more STSs. As shown in FIG. 2, racks 204 receive power from STS 116, racks 206 receive power from STS 210, and racks 208 receive power from STS 212.

The various components may be connected as follows. The first input of each of STSs 116, 210, and 212 may be connected to UPS 104 (which receives power from power source 102, such as a utility power line). The second input of each of STSs 116, 210, and 212 may be connected to UPS 124. Thus, STSs 116, 210, and 212 deliver power from UPS 104, unless power from UPS 104 fails or degrades below some level, in which case STSs 116, 210, and 212 deliver power from UPS 124. Each of the racks has two PDUs, one of which receives power from an STS, the other of which receives power directly from UPS 104. Thus, each of racks 204 has a PDU that receives power from STS 116, and another PDU that receives power directly from UPS 104 without an intervening STS. Likewise, each of racks 206 has a PDU that receives power from STS 210, and another PDU that receives power from UPS 104 without an intervening STS. And each of racks 208 has a PDU that receives power from STS 212, and another PDU that receives power from UPS 104 without an intervening STS. In this way, the various racks in group 203 are able to power dual-corded devices at both cords, unless UPS 104 fails; in such a case, the STSs switch power from UPS 104 to UPS 124, power at one of the PDUs for each rack loses power, and the entire load of the equipment in the racks transfers to the PDU that is connected to an STS.

Data center 202 may have several groups of racks, where each group may be wired according to the topology described above. Each group may have its own main UPS, and also may have an assigned reserve UPS (where the reserve UPS may be dedicated to that group, or may be shared among various groups).

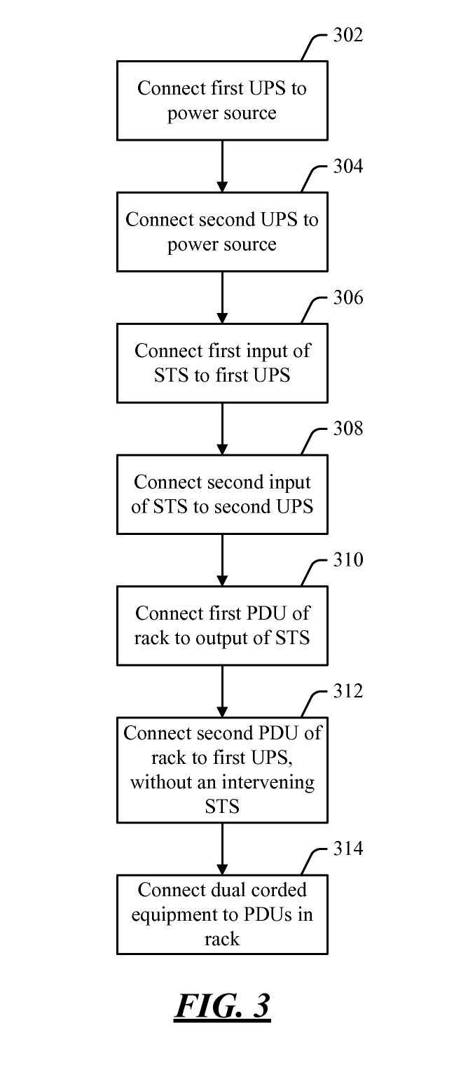

FIG. 3 shows an example process that may be used to wire a data center according to the topology described above. It is noted that the various stages of the process of FIG. 3 are shown in a particular order, as indicated by the lines connecting the blocks, but the process of FIG. 3 is not limited to the order shown. Moreover, these stages may be performed in any combination or sub-combination.

At 302, a first UPS is connected to a power source. For example, the first UPS may be connected to utility power, or to an on-site generator. At 304, a second UPS may also be connected to a power source, such as a utility or an on-site generator. The power source to which the second UPS is connected may be the same as the one to which the first UPS is connected, or may be a different power source.

At 306, the first input of an STS may be connected to the first UPS. At 308, the second input of an STS may be connected to the second UPS. The STS may be chosen to be able to handle a significant load change (e.g., doubling of the load) during a transfer; moreover, the STS may be chosen to handle such a load change during a transfer even if the power sources that acts as inputs to the STS are out of phase. At 310, the first PDU of a rack may be connected to the output of the STS. At 312, the second PDU of a rack may be connected to the first UPS, without an intervening STS. Thus, in the process of FIG. 3, it may be the case that the second UPS is not connected to the second PDU of the rack in any way, in which case the second PDU of the rack would not draw any power from the second UPS if the first UPS fails.

At 314, dual-corded equipment may be connected to the PDUs in the rack, such that each dual-corded piece of equipment has one cord connected to one PDU, and the other cord connected to the other PDU.

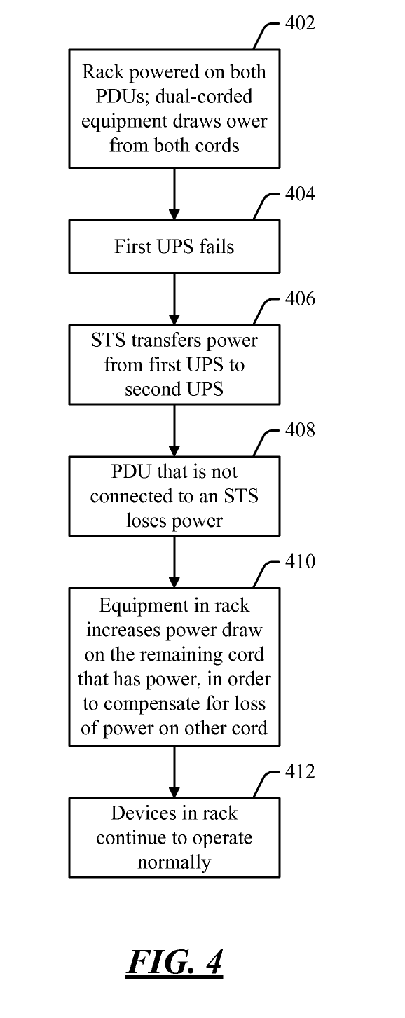

FIG. 4 is a flow diagram of an example process that may occur during failure of a UPS. As is the case in FIG. 3, the order shown among the blocks is non-limiting, and the stages shown may occur in any combination or sub-combination.

At 402, the current state of a group of racks in a data center is that both PDUs in a rack are powered, and dual-corded equipment in the rack draws power from both of its PDUs. Moreover, the rack is being powered through a first (main) UPS, and is also assigned to a second (reserve) UPS.

At 404, the first UPS fails. As a result of this failure, the STS transfers power from the first UPS to the second UPS (at 406). At 408, in a rack served by the failed UPS, the PDU that is not connected to a UPS loses power. Due to the loss of power, dual-corded equipment in the rack loses power in the cord that is connected to that PDU, and, therefore, at 410, increases its power draw on its other cord (which is connected to the PDU that receives power from the STS). This increased power draw on the other cord compensates for the loss of power; it approximately doubles the power draw on the cord that is receiving power, and it occurs at nearly the same time as the STS is transferring power. Since the dual-corded devices in the rack are continuing to receive power (although now through only one cord instead of two), these devices continue to operate normally.

As a matter of terminology, it is noted that components may be described as being “distinct” if they are not the same component. For example, it might be said that there is a first UPS and a second UPS that is distinct from the first UPS. These words describe the situation in which there are two UPSs. It might or might not be the case that the first UPS is identical to the second UPS. However, since the first UPS and the second UPS do not refer to the same physical instance of a device, these UPSs may be described as being distinct.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A data center comprising:
a first Uninterruptable Power Supply (UPS);
a second UPS that is distinct from said first UPS;
a static transfer switch (STS) having a first input connected to said first UPS, a second input connected to said second UPS, and an output; and
a dual-corded equipment unit that is able to receive power through a first cord and through a second cord, said first cord being connected to said output of said STS, said second cord being connected to said first UPS without any intervening STS.

2. The data center of claim 1, wherein said first UPS is connected to a power source, and wherein said second UPS is connected to said power source.

3. The data center of claim 1, wherein said equipment unit comprises a server computer.

4. The data center of claim 1, wherein said equipment unit is mounted in a rack with other dual-corded equipment units, wherein each of the dual-corded equipment units in said rack has one of its cords connected to said output of said STS and has the other one of its cords connected to said first UPS without any intervening STS.

5. The data center of claim 1, further comprising:
a first power distribution unit (PDU) that is connected to said output of said STS; and
a second PDU that is connected to said first UPS without any intervening STS;
wherein said first cord is connected to said output of said STS by being plugged into said first PDU, and wherein said second cord is connected to said first UPS by being plugged into said second PDU.

6. The data center of claim 1, wherein said second cord has no connection through which it can draw power from said second UPS.

7. The data center of claim 1, wherein said STS is configured to handle a doubling of a load on said STS during a transfer between out-of-phase sources.

8. A method of wiring a data center, the method comprising:
connecting a first input of a static transfer switch (STS) to a first uninterruptable power supply (UPS);
connecting a second UPS to a second input of said STS, said second UPS being distinct from said first UPS;
connecting a first cord of a dual-corded equipment unit to an output of said STS; and
connecting a second cord of said dual-corded equipment unit to said first UPS without there being any intervening STS being said second cord and said first UPS.

9. The method of claim 8, further comprising:
connecting said first UPS to a power source; and
connecting said second UPS to said power source.

10. The method of claim 8, said dual-corded equipment unit comprising a server computer.

11. The method of claim 8, said dual-corded equipment unit being mounted in a rack with other dual-corded equipment units, each of the dual-corded equipment units in said rack having one of its cords connected to said output of said STS and having the other one of its cords connected to said first UPS without any intervening STS.

12. The method of claim 8, further comprising:
connecting a first power distribution unit (PDU) to said output of said STS; and
connecting a second PDU to said first UPS without any intervening STS;
wherein said connecting of said first cord to said output of said STS comprises plugging said first cord into said first PDU, and wherein said connecting of said second cord to said first UPS comprises plugging said second cord into said second PDU.

13. The method of claim 8, said second cord having no connection through which it can draw power from said second UPS.

14. The method of claim 8, said STS being configured to handle a doubling of a load on said STS during a transfer between out-of-phase sources.

15. A method of providing power during a failure, the method comprising:
using a static transfer switch (STS) to transfer power from a first uninterruptable power supply (UPS) to a second UPS, an output of said STS being connected to a first cord of a dual-corded equipment unit; and
allowing a second cord of said dual-corded equipment unit to lose power in response to a failure of said first UPS, said second cord being connected to said first UPS and not being able to receive power from said second UPS.

16. The method of claim 15, further comprising:
connecting said first UPS to a power source; and
connecting said second UPS to said power source.

17. The method of claim 15, further comprising:
mounting said dual-corded equipment unit in a rack with other dual-corded equipment units;
for each of the dual-corded equipment units in the rack, performing acts comprising:
connecting one cord to said output of said STS; and
connecting another cord to said first UPS without any intervening STS.

18. The method of claim 15, further comprising:
connecting a first power distribution unit (PDU) to said output of said STS;
connecting a second PDU to said first UPS without any intervening STS;
connecting said first cord to said output of said STS by plugging said first cord into said first PDU; and
connecting said second cord to said first UPS by plugging said second cord into said second PDU.

19. The method of claim 15, said dual-corded equipment unit ca server computer.

20. The method of claim 15, said STS being configured to handle a doubling of a load on said STS during a transfer between out-of-phase sources.
